(19) United States
(12) Patent Application Publication
(10) Pub. No.: US 2021/0146897 A1
(43) Pub. Date: May 20, 2021

(54) Method for Operating a Braking Assembly of a Motor Vehicle, and Control and/or Regulation Device

(71) Applicant: Robert Bosch GmbH, Stuttgart (DE)

(72) Inventors: Edith Mannherz, Yokohama, Kanagawa (JP); Philipp Schmaelzle, Leonberg (DE)

(21) Appl. No.: 16/624,354

(22) PCT Filed: Jun. 6, 2018
(86) PCT No.: PCT/EP2018/064869

§ 371 Date: Dec. 19, 2019

(30) Foreign Application Priority Data
Jul. 13, 2017 (DE) 10 2017 211 995.0

(51) Int. Cl. B60T 8/32; B60T 7/12; B60T 8/17; B60T 8/96; B60T 13/74; B60T 7/08; B60T 13/58; B60T 8/171; B60T 17/22; B60T 8/36; F16D 65/16

(52) U.S. Cl. CPC B60T 8/3275; F16D 2125/40; B60T 8/17; B60T 8/96; B60T 13/746; B60T 7/08; B60T 13/58; B60T 8/171; B60T 17/221; B60T 8/36; F16D 65/16; B60T 2201/03; B60T 2270/402; B60T 2250/00; B60T 2201/12; B60T 2240/00; B60T 7/12

(57) ABSTRACT

The disclosure relates to a method for operating a braking assembly of a motor vehicle, in which a first hydraulic braking system is operated as a function of a target deceleration. A second electromechanical braking system can be activated for decelerating the motor vehicle. It is proposed that a braking force of the second braking system is dependent on an actual deceleration.

### PRIOR ART

The invention relates to a method for operating a brake assembly of a motor vehicle, and an open- and/or closed-loop control unit for a brake assembly of a motor vehicle according to the precharacterizing clauses of the co-ordinate claims.

### DISCLOSURE OF THE INVENTION

DE 10 2014 203 322 A1 describes a method for generating an emergency deceleration of a moving vehicle. In this case, a first hydraulic brake system for decelerating the front wheels and a second electromechanical brake system, which acts on the rear wheels of the vehicle, are provided as an electromechanical parking brake. It is further known from the market to activate an electromechanical parking brake, provided as a second brake system, for decelerating the motor vehicle when a malfunction is established in a first hydraulic brake system. In this case, the brake force (which here refers, for example, to that clamping force with which a brake disk is clamped between two brake shoes) is controlled in that the motor current of a servomotor of a brake actuator of the second brake system is used, for example, as a control variable. For example, this motor current is recorded with corresponding tolerances and the activation is maintained until a specified target value is reached.

The present invention has the object of providing a method with which safe deceleration of a motor vehicle, which is especially independent of many external influence factors, can also be achieved in the event of a failure of the first hydraulic brake system.

This object is achieved by a method having the features of claim 1, and by an open- and/or closed-loop control unit having the features of the co-ordinate claim. Advantageous further developments are indicated in the subclaims. Moreover, features which are essential to the invention are found in the description below and in the accompanying drawing. In this case, these features can be essential to the invention both in isolation and in different combinations, without being explicitly referenced again.

In the method according to the invention, a first hydraulic brake system is operated depending on a target deceleration. A second electromechanical brake system can be activated for decelerating the motor vehicle, i.e. when the motor vehicle is moving. According to the invention, it is proposed that a brake force provided by the second brake system depends on an actual deceleration, i.e. is generated taking into account an actual deceleration.

It is therefore possible, according to the invention, to also precisely and reproducibly set a vehicle deceleration when using the second electromechanical brake system. This results in further options for the use of the electromechanical brake system, for example also for dynamic braking maneuvers. Therefore, a fallback level of the first brake system can be expanded and configured more freely and the overall availability of the brake assembly can thus be increased.

Difficulties adapting the braking behavior to varying general and environmental conditions are also reduced. For example, in the case of a vehicle, it is possible for the load status on the one hand and a brake-disk coefficient of friction of a brake disk of the electromechanical brake system on the other to vary. Since, in the present invention, the brake force of the second brake system depends on an actual deceleration, the expected vehicle deceleration, i.e. the target vehicle deceleration, can always be adjusted if this is physically achievable. The core of the invention is therefore to control a brake force of the second brake system in such a way that a requested deceleration of the motor vehicle (target deceleration) is adjusted.

It goes without saying that the invention can also be used in brake assemblies such as those in which the hydraulic brake system and the electromechanical brake system are completely independent of one another in that they each comprise separate components. However, the implementation is conventionally realized such that, for example, electric motors of the electromechanical brake system and other additionally required components, such as a spindle nut system, for example, are integrated directly on a brake caliper of the hydraulic brake system, which is usually realized on the rear axle of a motor vehicle. This means that the first hydraulic brake system and the second electromechanical brake system use the same brake caliper and brake piston and the same brake disks. In this case, the brake piston can be either displaced hydraulically or moved electromechanically, for example by a spindle nut.

At this point, it should further be pointed out that a dependence of the brake force of a brake system on an actual deceleration cannot only be realized in the case of an additional electromechanical brake system, but in any type of brake system, i.e. also in a simple hydraulic brake system. In principle, this represents an independent claimable invention. The only prerequisite is that an option is provided which enables a deceleration requested by a driver of the motor vehicle (“driver brake request”) to be quantified. At its most simple, this is enabled via a sensor on a brake pedal.

A first further development of the method according to the invention is notable in that the second brake system is activated automatically when a malfunction of the first brake system is established and a brake demand by a driver exists. This increases the operational safety of the motor vehicle considerably and eases the pressure on the driver of the motor vehicle.

It is also possible that the second brake system is activated when the driver actuates a corresponding actuating element. If the second, electromechanical brake system is an automatic parking brake (APB), such an actuating element is present in any case, since, with this, the driver can actuate the parking brake manually when the motor vehicle is stationary. However, situations can also arise in which the driver or another person located in the motor vehicle would like to decelerate the motor vehicle by means of the second brake system when the motor vehicle is not stationary, for example if a failure of the first brake system is established or if the driver is incapacitated. In this case, the person can activate the second brake system manually and safe deceleration of the vehicle is ensured by controlling the brake force of the second brake system so that a specified vehicle deceleration is achieved.

It is particularly advantageous if the brake force of the second brake system is controlled by at least one first control loop, whereof the input variable is an actual deceleration, in particular an actual wheel deceleration, or an equivalent variable. This can be realized simply and permits direct control of the actual deceleration to a target deceleration. If this first control loop is provided in isolation, it should be configured to be relatively slow in order to compensate the comparatively high inertia of the controlled system formed by the motor vehicle.

It is furthermore particularly advantageous if the brake force of the second brake system is controlled by at least one second control loop, whereof the input variable is an actual brake force or an equivalent variable, wherein the first control loop and the second control loop together form a cascade structure. This results in an “inner” control loop, namely the second control loop, and an outer control loop, namely the first control loop. The inner control loop attempts to adjust the specified value of the outer control loop. The deceleration is fed back via the outer control loop and too slow a deceleration is recorded and adapted according to the specified force value (target brake force) or the equivalent variable for the inner control loop. As a result of such a cascade structure, an, on the whole, comparatively quick closed-loop control can be achieved so that the actual deceleration very quickly reaches the target deceleration.

In a further development of this, it is proposed that the equivalent variable is an actual motor torque of a servomotor of a brake actuator, an actual motor current of the servomotor of the brake actuator or an actual adjustment travel of a final control element of the brake actuator. The actual motor current is an easily recorded variable, which is present in any case in many cases. The actual motor torque and the actual adjustment travel can be estimated in a simple manner from the actual current and an actual voltage. Precise implementation of a closed-loop control according to the invention is enabled using the said variables.

In this case, it is possible that the actual brake force or the equivalent variable is recorded by means of a recording device or estimated by means of an estimation procedure. Particularly precise closed-loop control is possible if the variable is recorded by a recording device. On the other hand, if the variable is estimated using an estimation procedure, for example an observation procedure, it is possible to dispense with a recording device, thereby reducing costs.

It is particularly advantageous if a pilot control is provided, which generates a pilot control value of the actual brake force or the equivalent variable from the target deceleration. If a second control loop is provided, the generated pilot control value can be supplied to the second control loop at the start as a fed-back variable. The setting of the actual deceleration to the target deceleration is thus accelerated again.

Following the same lines is that further development in which, immediately after the activation of the second brake system, an air gap between an actuating element, in particular a spindle nut, and a counter-piece, in particular a brake piston, is reduced.

Also belonging to the invention is a control unit for a brake assembly of a motor vehicle, having a processor and a memory, wherein the control unit is designed for executing a method as claimed in one of the preceding claims.

Exemplary embodiments of the invention are explained below, with reference to the accompanying drawing. The drawing shows:

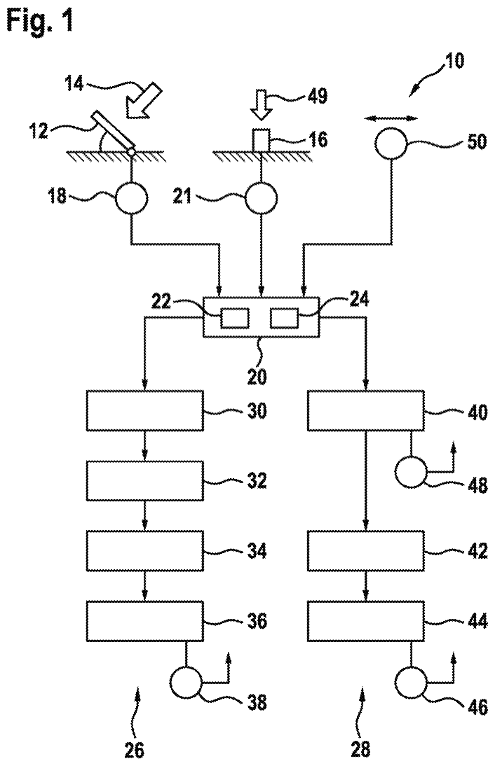

FIG. 1 a schematic block diagram of a brake assembly of a motor vehicle;

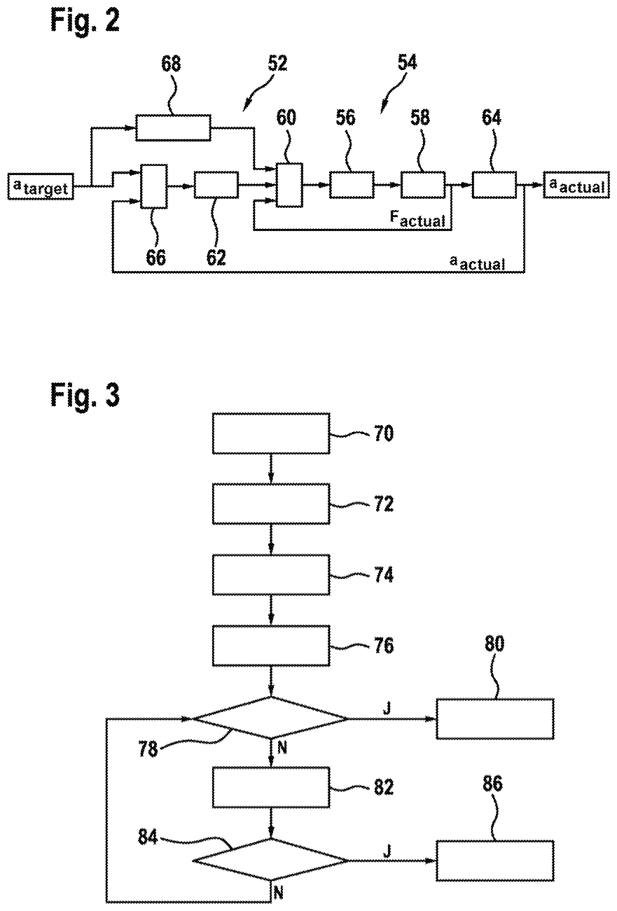

FIG. 2 a function diagram of a first embodiment of a closed-loop control of the brake assembly of FIG. 1;

FIG. 3 a flow chart of a closed-loop control of FIG. 2;

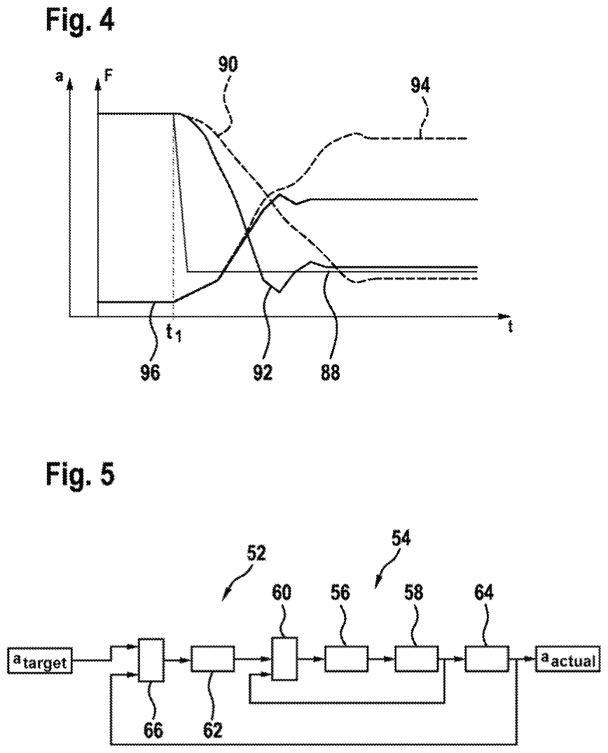

FIG. 4 a chart in which a brake force and a deceleration of a motor vehicle over time are plotted for two different load statuses of the motor vehicle;

FIG. 5 a function diagram, similar to FIG. 2, of a second embodiment; and

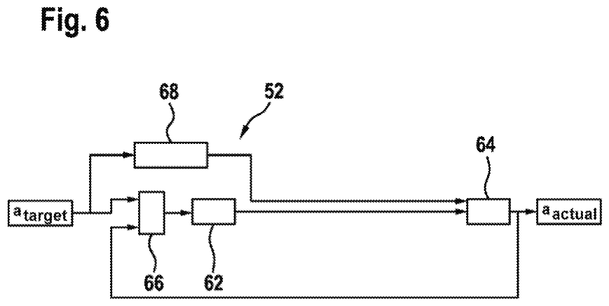

FIG. 6 a function diagram, similar to FIG. 2, of a third embodiment.

Those elements, fields and function blocks which have equivalent functions to elements, fields and function blocks described above are denoted by the same reference signs below. They are not explained again in detail.

A brake assembly of a motor vehicle is denoted as a whole by the reference sign 10 in FIG. 1. The motor vehicle itself is not shown in FIG. 1. However this can refer to any motor vehicle, for example an automobile, a motor bike or a truck.

A brake pedal 12, which can be actuated by a driver of the motor vehicle according to the arrow 14, firstly belongs to the brake assembly. As a result of a corresponding force, which is exerted on the brake pedal 12 by the driver, a certain requested deceleration (target deceleration a_{target}) is realized. An actuating element 16, for example in the form of a push button or control switch, the function of which will be discussed in greater detail below, further belongs to the brake assembly. The force which is exerted on the brake pedal 12 by the driver is recorded by a sensor 18 which delivers a signal corresponding to the requested deceleration a_{target} to a control unit 20. The position of the actuating element 16 is recorded by a sensor 21, which likewise delivers a corresponding signal to the control unit 20. The control unit 20 comprises a processor 22 and a memory 24. A computer program is stored in the memory 24, which computer program can be processed and executed in the processor 22, as is likewise laid out in greater detail below.

The brake assembly 10 has two substantially mutually independent brake systems. A first hydraulic brake system 26 is shown on the left in FIG. 1, a second electromechanical brake system 28 is shown on the right in FIG. 1. Both brake systems 26 and 28 are controlled by the control unit 20. The first hydraulic brake system 26 comprises a servomotor 30, which can generate a certain hydraulic pressure in a hydraulic system 32. This hydraulic pressure acts on a brake 34, which comprises brake shoes which can be moved by the hydraulic pressure, for example. The servomotor 30, the hydraulic system 32 and the brake 34, as a whole, form a brake actuator (no reference sign). The brake 34 in turn acts on a wheel system 36, which comprises, for example, a wheel and a brake disk, which is rigidly connected to said wheel and on which the said brake shoes can act. A rotational speed of the wheel system 36 is recorded by a wheel sensor 38. The change over time of the rotational speed also results in an acceleration or a deceleration of the wheel system 36. The wheel sensor 38 delivers a corresponding signal to the control unit 20.

The second electromechanical brake system 28 likewise comprises a servomotor 40, which, for example, acts directly on a brake 42 by means of a spindle (not illustrated). The servomotor 40 and the brake 42, as a whole, also form a brake actuator (no reference sign). In this case, the spindle (not illustrated) forms a final control element of the brake actuator. The brake can comprise brake shoes, for example. The brake 42 also acts on a wheel system 44 here, which, by way of example, can in turn comprise a wheel and a brake disk which is rigidly connected to said wheel and on which the recently mentioned brake shoes can act. A rotational speed of the wheel system 44 is recorded by a wheel sensor 46. The change over time of the rotational speed also results in an acceleration or a deceleration of the wheel system 44. An actual motor torque or an actual motor current of the servomotor 40 or an actual adjustment travel of the spindle are recorded by a sensor 48. Both the wheel sensor 46 and the sensor 48 deliver corresponding signals to the control unit 20.

In the embodiment described in the present case, the hydraulic brake system and the electromechanical brake system are therefore completely independent of one another in that they each comprise separate components. In one embodiment (not illustrated), the implementation is, however, realized such that the servomotor of the electromechanical brake system acts on the same brake as the servomotor of the hydraulic brake system. This is also referred to as a “motor on caliper” system. In such a system, therefore, the same brake calipers, brake disks, brake pistons etc. are used for the hydraulic brake system.

The second electromechanical brake system 28 is itself provided as an electric and possibly also automatically operating parking brake (APB). This can be activated either automatically when the vehicle is stationary or manually at the demand of the driver, in that he actuates the actuating element 16 according to the arrow 49. As will be described in greater detail below, the second electromechanical brake system 28 can, however, also serve as an emergency brake system if the first hydraulic brake system 26 operates in a faulty manner or does not operate at all.

A deceleration sensor 50, which records a deceleration of the motor vehicle overall in the longitudinal direction of the motor vehicle and emits a corresponding signal to the control unit 20, also belongs to the brake assembly 10.

Overall, the brake assembly 10 operates as follows: should the driver wish to decelerate the moving motor vehicle, he normally presses on the brake pedal 12 according to the arrow 14 and thereby expresses a request for a deceleration of the motor vehicle (target deceleration a_{target}) which corresponds to the force with which he presses on the brake pedal 12. The servomotor 30 is therefore controlled by the control unit 20 and a certain hydraulic pressure is generated in the hydraulic system 32. This acts on the brake 34, which brakes the wheel system 36. The actual deceleration a_{actual} is recorded, on the one hand, by the wheel sensor 38 and, on the other, by the deceleration sensor 50. In this case, the brake force F, i.e. the clamping force with which the brake shoes of the brake 42 press on the brake disk of the wheel system 44 or the brake disk is clamped between the two brake shoes of the brake 42, is controlled such that the actual deceleration a_{actual} corresponds as closely as possible to the target deceleration a_{target}.

In one embodiment (not illustrated), the first hydraulic brake system is not controlled “automatically”. Instead, the “control” is assumed by the driver of the motor vehicle, who adapts the actual deceleration by adapting the force with which he presses on the brake pedal to the target deceleration he requires.

However, if it is established by the control unit 20 that the first brake system 26 is operating in a faulty manner or not operating at all, the second brake system 28 is automatically activated as an “emergency brake system”, i.e. when the motor vehicle is moving. To this end, the servomotor 40 is controlled such that the brake shoes of the brake 42 press on the brake disk of the wheel system 44 with a certain brake force F_{target}, so that the actual deceleration a_{actual} corresponds as closely as possible to the target deceleration a_{target}. The same thing happens when the driver or another person located in the motor vehicle intentionally actuates the actuating element 16 according to the arrow 49 when the vehicle is moving.

In current practice, the actuating element 16 is configured as a so-called “push/pull switch”. With such an actuating element 16, the driver of the motor vehicle is unable to input the target deceleration he requires. Instead, it is merely established by such an actuating element 16 that a brake request exists. In such a case, a fixed value is assumed as the target deceleration a_{target}, for example 2 m/s², or the maximum deceleration which is physically possible is assumed as the target deceleration.

To achieve that, upon the activation of the second, electromechanical brake system 28, the actual deceleration a_{actual} corresponds as closely as possible to the target deceleration a_{target}, a closed-loop control is provided which will now be explained in detail, firstly with reference to FIG. 2. According to the block diagram of a closed-loop control, which is illustrated in FIG. 2, this control comprises a first “outer” control loop 52 and a second “inner” control loop 54. The control loops 52 and 54 are standard control loops. The second inner control loop 54 comprises a controller 56 and a controlled system 58. The controlled system 58 forms the components of the second brake system 28. For example, an actual brake force F_{actual}, estimated via an estimation procedure, is fed back. Alternatively, a motor torque or a motor current (each recorded by the sensor 48 or estimated via an estimation procedure on the basis of current and voltage) could also be fed back. A control deviation between the target brake force F_{target} (control variable) and the actual brake force F_{actual} is formed in 60.

The outer control loop 52 comprises a controller 62, which outputs the target brake force F_{target} to the subtractor 60 of the controller 56 of the second inner control loop 54. A controlled system 64, which is formed by components of the motor vehicle, belongs to the first outer control loop 52. The actual deceleration a_{actual} of the motor vehicle, which is determined by means of the sensor 50, is fed back. Alternatively, the deceleration at the wheel system 44, which is recorded by means of the sensor 46, could also be fed back. A control deviation between the target deceleration a_{target} (control variable) and the actual deceleration a_{actual} is formed in 66.

By using a pilot control, the dynamics of the system as a whole can be improved. This pilot control is denoted by 68 in FIG. 2. In the pilot control, a target brake force F_{target} is determined directly from the target deceleration a_{target}, which target brake force is fed directly into the subtractor 60 of the second inner control loop 54, bypassing the controller 62.

The sequence of a method for operating the brake assembly 10, and in particular the second electromechanical brake system 28, is now explained with reference to FIG. 3: in a block 70, the driver of the motor vehicle expresses his brake request. In a block 72, the value of the requested target deceleration a_{target} is identified from the signal of the sensor 18. On the basis of this, in a block 74, the control variable a_{target} is generated. In a block 76, the requested target deceleration a_{target} is compared to the actual deceleration a_{actual} recorded, for example, by the sensor 50. In a block 78, it is enquired whether or not the actual deceleration a_{actual} has reached the target deceleration a_{target}. If the answer is Yes, the command to maintain the brake force F_{actual} is output in 80. On the other hand, if the answer in block 78 is No, the brake force F_{actual} is adapted in block 82. The brake force F_{actual} provided by the second brake system 28 is therefore generated taking into account the actual deceleration a_{actual}; it is therefore dependent on the actual deceleration a_{actual}. In a block 84, it is enquired whether the wheel system 44 is locked. If the answer is Yes, a counter-measure is introduced in a block 86. On the other hand, if the answer is No, a jump back to block 78 is realized.

As a result of the closed-loop control described above, it is possible, even with different loads of the motor vehicle or with different coefficients of friction between the brake 42 and the wheel system 44, to still achieve an actual deceleration a_{actual} corresponding to the target deceleration a_{target}. This is revealed, for example, in the graph illustrated in FIG. 4. The x-axis of the graph in FIG. 4 corresponds to a time t, the two coordinates correspond to the brake force F and the deceleration a. At a point in time t₁, a specified target deceleration a_{target} is forwarded to the closed-loop control. In FIG. 4, the corresponding curve is denoted by the reference sign 88. Therefore, either the second brake system 28 is activated automatically by the control unit 20 in the event of a failure of the first brake system 26 or the second brake system 28 is activated by manual actuation of the actuating element 16. The specified deceleration a_{target} can be a standard value by which, in the two cases mentioned, the motor vehicle is to be decelerated. However, it can also be that value which is produced from the force with which the driver presses down the brake pedal 12.

A progression of an actual deceleration a_{actual} in the case of a highly loaded vehicle is denoted by the reference sign 90 in FIG. 4; the progression of an actual deceleration a_{actual} in the case of an only slightly loaded vehicle is denoted by the reference sign 92 in FIG. 1. The progression of an actual brake force F_{actual} in the case of a highly loaded vehicle is denoted by the reference sign 94 in FIG. 4; the curve of an actual brake force F_{actual} in the case of an only slightly loaded vehicle is denoted by the reference sign 96 in FIG. 4.

It can be seen from the graph in FIG. 4 that a corresponding specified value is firstly specified at the second inner control loop 54 by the pilot control 68. The controller 62 of the first outer control loop 52 also supplies part of the control variable, wherein the value is dependent on the type of controller 62 selected. The actual brake force (curves 94 and 96) is still zero at the start, i.e. at the point in time t₁. From this point in time, the second inner control loop 54 starts to adjust its control variable F_{actual} to the target value F_{target} (not illustrated in the graph). Owing to the accumulating brake force F, the motor vehicle decelerates by an actual deceleration a_{actual}. It can be seen via the progression of the curve 94 that, in the case of a highly loaded motor vehicle, the pilot-controlled brake force F_{actual} is not sufficient to achieve the desired deceleration a_{target}. The outer control loop 52 must therefore forward a higher value of the brake force F_{target} to the second inner control loop 54 via its controller 62 in order to adjust the desired target deceleration a_{target}. It can be seen very clearly that, in the case of a fully loaded vehicle, the brake force F_{target} (curve 94) is higher than the brake force F_{target} (curve 96) in the case of an only slightly loaded motor vehicle. The influence of the higher load will therefore be compensated by applying a higher brake force F_{actual}.

However, it goes without saying that, by means of the closed-loop control described above, not only is a varying load of the motor vehicle compensated, but also other deviations of the controlled system 58 of the second inner control loop 54, which is formed by the components of the second electromechanical brake system 28. Such deviations could be caused, for example, by faulty current measurement, whereby, for example, too high a motor current of the servomotor 40 is recorded. Assuming that the brake force is at least approximately proportional to the motor current, in this case too high an actual brake force F_{actual} is forwarded. This too high a value of the actual brake force F_{actual} is also fed back in this closed-loop control; however, via the first outer control loop 52 and the feedback of the actual deceleration a_{actual}, the insufficient actual deceleration a_{actual} is recorded and the specified target brake force F_{target} is increased to a higher value.

Further deviations can be caused, for example, by a fluctuation in the measured supply voltage for the servomotor 40 as a result of measuring tolerances. An influence of the speed of the motor vehicle, an incline of a roadway on which the motor vehicle is travelling, a parameter of the specifically installed servomotor 40, a coefficient of friction of a brake disk, a coefficient of friction of the road surface and/or the efficiency of a transmission which is used in the second brake system 28 can also be compensated by the closed-loop control described above.

A second embodiment of a closed-loop control of the second electromechanical brake system 28 is illustrated in FIG. 5. This is identical to the embodiment of FIG. 2, although a pilot control is not present.

A third embodiment of a closed-loop control of the second electromechanical brake system 28 is illustrated in FIG. 6. Although a pilot control is present in this, the inner control loop is omitted. This is therefore a single standard control loop, in which only the actual deceleration a_{actual} of the motor vehicle (sensor 50) or the wheel system 44 (wheel sensor 46) is fed back. However, owing to the inertia of the controlled system, such a single control loop should be configured to be comparatively slow.

In the above embodiments, the brake force F has been used as a control variable of the second control loop 54 in each case. In other embodiments (not illustrated), an estimated motor torque or a measured motor current or an estimated actual adjustment travel of a final control element of the brake actuator can be used as the control variable of the second inner control loop.

If the dynamics of the closed-loop control are to be further improved, i.e. the actual deceleration a_{actual} is to be brought closer to the target deceleration a_{target}, an electromechanical air gap can be reduced when a deceleration demand is established (point in time t₁ in the above graph according to FIG. 4), i.e. immediately after the activation of the second brake system 28. An actuating spindle of the electromechanical brake system is not held close to a brake piston when the brakes are released, but somewhat behind it so as not to influence the brake piston when the vehicle is moving. This “security” can be reduced when a deceleration demand has been established, in that the actuating spindle is moved somewhat in the direction of the brake piston.

The closed-loop controls described above are stored as a computer program in the memory 24 of the control unit 20. The closed-loop control is executed in that the stored computer program is executed by the processor 22.

1. A method for operating a brake assembly of a motor vehicle, the method comprising:
operating a first hydraulic brake system depending on a target deceleration; and
decelerating the motor vehicle by activating a second electromechanical brake system to generate a brake force depending on an actual deceleration.

2. The method as claimed in claim 1, further comprising:
automatically activating the second electromechanical brake system in response to (i) a malfunction of the first brake system being established and (ii) a brake demand by a driver existing.

3. The method as claimed in claim 1, further comprising:
activating the second electromechanical brake system in response to a driver actuating a corresponding actuating element.

4. The method as claimed in claim 1, further comprising:
controlling the brake force generated by the second electromechanical brake system with at least one first control loop, wherein one of (i) the actual deceleration and (ii) a first variable that is equivalent to the actual deceleration is an input variable of the at least one first control loop.

5. The method as claimed in claim 4, further comprising:
controlling the brake force generated by the second electromechanical brake system with at least one second control loop, wherein one of (i) an actual brake force and (ii) a second variable that is equivalent to the actual brake force is an input variable of the at least one second control loop, wherein the first control loop and the second control loop together form a cascade structure.

6. The method as claimed in claim 5, wherein the second variable is one of (i) an actual motor torque of a servomotor of a brake actuator, (ii) an actual motor current of the servomotor of the brake actuator, and (iii) an actual adjustment travel of a final control element of the brake actuator.

7. The method as claimed in claim 5, further comprising:
one of recording with a recording device and estimating with an estimation procedure, the one of (i) the actual brake force and (ii) the second variable.

8. The method as claimed in claim 5, further comprising:
providing a pilot control to generate a pilot control value of the one of (i) the actual brake force and (ii) the second variable, based on the target deceleration.

9. The method as claimed in claim 1, further comprising:
reducing, immediately after the activating the second brake system, an air gap between an actuating element, and a counter-piece.

10. A control unit for a brake assembly of a motor vehicle, the control unit comprising:
a memory; and
a processor configured to:
operate a first hydraulic brake system depending on a target deceleration; and
decelerate the motor vehicle by activating a second electromechanical brake system to generate a brake force depending on an actual deceleration.

11. The method as claimed in claim 4, wherein the input variable of the at least one first control loop is an actual wheel deceleration.

12. The method as claimed in claim 9, wherein the actuating element is a spindle nut and the counter-piece is a brake piston.
